(19) United States
(12) Patent Application Publication
(10) Pub. No.: US 2007/0260551 A1
(43) Pub. Date: Nov. 8, 2007

(54) Media Burning Terminal and System for Providing Digital Content

(76) Inventor: Andreas Eckleder, Karlsbad (DE)

Correspondence Address: GLENN PATENT GROUP, 3475 EDISON WAY, SUITE L, MENLO PARK, CA, 94025, US

(21) Appl. No.: 11/460,893

(22) Filed: Jul. 28, 2006

Related U.S. Application Data
(60) Provisional application No. 60/758,904, filed on Jan. 13, 2006.

(51) Int. Cl. H04L 9/00

(52) U.S. Cl. 705/59

(57) ABSTRACT

A media burning terminal having an account comprises a user interface for receiving a user input requesting a specified piece of digital content and further comprises a network interface for communicating with a clearing-house server managing the account, and for communicating with a license server. The media burning terminal further comprises a recorder for recording digital content on a portable medium and a controller for reading the user input, communicating with the clearing-house server for ordering a license for the specified piece of digital content using the account, for receiving the license from the license server, and for decrypting the specified piece of digital content using the license and controlling the recorder so that the recorder records the decrypted specified piece of digital content on the portable medium.

### FIELD OF THE INVENTION

The present invention relates to handling of digital content such as video information, audio information, text information, binary data etc., and, particularly, to the field of digital rights management, content distribution and secure content transmission.

### BACKGROUND OF THE INVENTION

There exist many ways to distribute encrypted content, as for example video information, audio information, text information, binary data files etc., to end users offering proper accounting and payment of fees to the content provider. A straight-forward way is to provide digital content in stores, i.e. to offer digital content on portable media, as for example DVDs (DVD=Digital Versatile Discs) or CDs (CD=Compact Disc) or Other portable media. Using this traditional way of vending digital content is a secure solution, however, the traditional way of vending media always brings along the problem of a restricted media spectrum, i.e., the variety of digital media at a store is always limited. Furthermore, offering digital media in form of portable mediums in a store requires space in order to advertise the media, and causes fixed costs as for example ware housing and personnel costs.

Another option for digital media provision is to use, for example the internet, and allow internet users to purchase digital content in online shops. A user then acquires an encrypted file and buys a key for decrypting the file from the content provider. Using the key, the user can decrypt the file and obtain a decrypted version of the content. However, although the internet solution circumvents the fixed costs, for example storage costs and service costs, this solution lacks providing adequate metadata replenishing a product. For example, if a user buys an audio CD from a store, a CD comes in a case, it is labeled, it has a booklet, for example containing the lyrics of the audio content, and it has an individual cover. Obtaining a decent cover, label, and booklet from the internet is generally not possible to an end user, unless the user has the proper labeling device and printers at his disposal.

Distributing digital content over the public internet also has severe security issues. A content provider allowing the mass of end users to access encrypted content, also faces many attacks from hackers, trying to decrypt the encrypted content and use it for their own nefarious purposes. Although encryption techniques have advanced during the past, the hacker community is succeeding in breaking decryption algorithms. Therefore, distribution of digital content over the internet allowing access to a large number of users always involves a certain degree of insecurity, although the content may be encrypted.

### SUMMARY OF THE INVENTION

It is therefore the objective of the present invention to provide a secure and efficient content distribution concept, which has an acceptable comfort level to the end users as well as an acceptable security level to the content providers.

This objective is achieved by a media burning terminal having an account, comprising a user interface for receiving a user input requesting a specified piece of digital content; a network interface for communicating with a clearing-house server, managing the account, and for communicating with a license server; a recorder for recording digital content on a portable medium; and a controller for reading the user input; communicating with the clearing-house server for ordering the license for the specified piece of digital content using the account; receiving the license from the license server; decrypting the specified piece of digital content using the license; and controlling the recorder so that the recorder records the decrypted specified piece of digital content on the portable medium.

Furthermore, the objective is achieved by a system for providing a specified piece of digital content, comprising a communication network; a content server being coupled to the communication network for providing encrypted digital content; a clearing-house server being coupled to the communication network, for receiving license orders from a media burning terminal, for managing account data and for issuing a license to a license server; the license server being coupled to the communication network, for receiving the license from the clearing-house server and for providing the received license to the media burning terminal; the media burning terminal being coupled to the communication network, for ordering the license for the specified piece of digital content from the clearing-house server, for receiving the license from the license server, for downloading an encrypted version of the specified piece of digital content from the content server, for decrypting the encrypted version of the specified piece of a digital content based on the received license, and for provision of the specified piece of digital content to the user.

The present invention is based on the finding that digital content can be provided in a secure and user-friendly manner, using a media burning terminal, which is embedded into a connected environment possibly consisting of multiple instances of media burning terminals located for example at stores worldwide, content servers providing protected content for download as well as a clearing-house server and a license server granting licenses for one-time burning of a particular digital content, as well as for accounting purposes.

### BRIEF DESCRIPTION OF THE DRAWING

Embodiments of the present invention will be detailed using the Figures. attached, in which:

FIG. 1 shows a block diagram of an embodiment of a media burning terminal;

FIG. 2 shows an embodiment of a system for providing digital content;

FIG. 3 shows another embodiment of a system for providing digital content;

FIG. 4 shows an embodiment of a flow chart at a media burning terminal;

FIG. 5 shows another embodiment of a flow chart at a media burning terminal; and

FIG. 6 shows an embodiment of an encryption method.

### DETAILED DESCRIPTION OF THE INVENTION

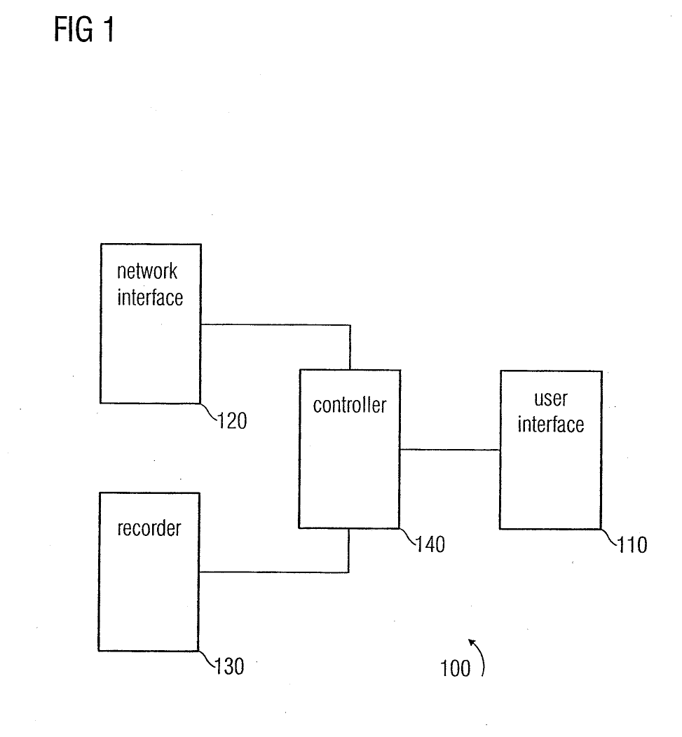

An embodiment of a media burning terminal 100 is depicted in FIG. 1. According to FIG. 1, the media burning terminal 100 is comprised of a user interface 110, a network interface 120, a recorder 130, and a controller 140. The user interface 110, the network interface 120, and the recorder 130 are directly connected to the controller 140. The media burning terminal 100 has an account, which entitles it to order a license for a specified piece of digital content. The user interface 110 is adapted for receiving a user input requesting the specified piece of digital content. The media burning terminal 100 uses the network interface 120 for communicating with a clearing-house server managing the account and for communicating with a license server. The recorder 130 is adapted for recording digital content on a portable medium. The controller 140 is adapted for reading the user input, for communicating with the clearing-house server for ordering the license for the specified piece of digital content using the account, and for receiving the license from the license server. The controller is further adapted for decrypting the specified piece of digital content using the license; and for controlling the recorder so that the recorder records the decrypted specified piece of digital content on the portable medium.

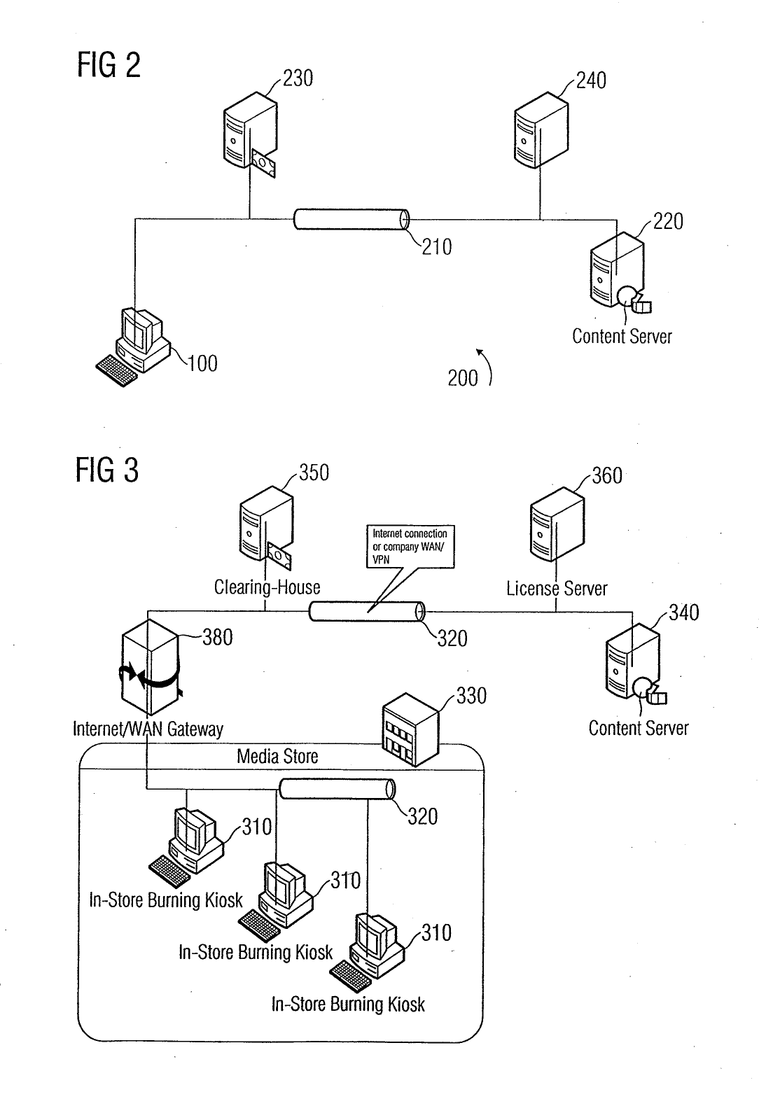

FIG. 2 illustrates an embodiment of a system 200 for providing a specified piece of digital content. The system 200 comprises a communication network 210, which interconnects all other system components. Moreover, the system comprises a content server 220 being coupled to the communication network 210. Furthermore, the system comprises a clearing-house server 230 and a license server 240, which are both coupled to the communication network 210. Moreover, the system comprises a media burning terminal 100, which is also coupled to the communication network 210, and which was described in more detail above using FIG. 1.

The content server 220 is adapted for provision of encrypted digital content, as for example audio files or images of audio CDs, video files and images of video DVDs, or any binary data, of which encrypted versions can be downloaded by the media burning terminal 100. The clearing-house server 230 is adapted for receiving license orders from the media burning terminal 100, for managing account data, and. for issuing a license to the license server 240. The license server 240 is adapted for receiving the license from the clearing-house server 230 and for providing the received license to the media burning terminal 100. The media burning terminal is adapted for ordering the license for the specified piece of digital content from the clearing-house server 230, for receiving the license from the license server 240, for downloading an encrypted version of the specified piece of digital content from the content server 220, for decrypting the encrypted version of the specified piece of digital content based on the license received from the license server 240, and for provision of the specified piece of digital content to a user.

In one embodiment of the present invention, a DVD-video-burning solution residing on a client platform, which corresponds to the media burning terminal 100, is embedded into an online delivery system, which corresponds to the system 200 for providing a specified piece of digital content, for video content to be sold to consumers. The principle idea of this embodiment is to have a connected burning kiosk, i.e. a media burning terminal 100, available at major media stores to burn content that is not available in physical stock.

In this embodiment, the recorder 130 corresponds to a DVD-burning device, built in, for example a personal computer, corresponding to the media burning terminal 100. Recording is done on dedicated media that do allow content to be encrypted, for example using CSS (CSS=Content Scrambling System) encryption. Aside from media that will be able to store CSS disc keys, this embodiment also requires dedicated recorders 130 that allow the writing of both disc keys and title keys to those media. Media recorded this way are playable on standard consumer DVD-video players.

Another embodiment is shown in FIG. 3. FIG. 3 shows instore burning kiosks 310, of which each one corresponds to a media burning terminal 100 described in FIG. 1, the instore burning kiosks 310, or also called DVD-video-burning kiosks, are embedded into a connected environment or communication network 320 consisting of multiple instances of burning kiosks 310 located at stores 330 worldwide, content servers 340 providing the encrypted content for download as well as a clearing-house server 350 and a license server 360 granting licenses, e.g. for one-time burning of a particular movie. The in-store burning kiosks 310 could be interconnected using a company network 370 utilizing an internet or wide-area network (WAN) gateway 380 to connect to network components located outside the company network 370.

An in-store burning kiosk 310 corresponds to a device that can be used to burn DVD-video discs using images obtained from an online content store, in FIG. 3 represented by the content server 340. The in-store burning kiosk 310 is held ready at stores for consumers to be able to buy titles that are not available in general stock. The content server 340 represents a server located on the internet or a company WAN (WAN=Wide Area Network). It may use a popular file transfer protocol, such as HTTP (HTTP=Hyper Text Transfer Protocol) or FTP (FTP=File Transfer Protocol) to provide access to DRM (DRM=Digital Rights Management) protected content and additional information such as disc label images, title information, covers, booklets, etc.

The clearing-house server 350 also corresponds to a server located on the internet or a company WAN. It keeps track of content orders from an in-store burning kiosk 310 and issues a license for burning once a transaction of ordered content has been completed. Once the clearing-house server 350 has issued a license, the license is stored at a license server 360, which represents a server located on the internet or a company WAN as well. The licenses are stored at the license server after they have been ordered. Each time a title is written to a disc or otherwise processed, the license server needs to be contacted by the in-store burning kiosk 310 to obtain the license. The license itself corresponds in this embodiment to an electronic document containing conditions under which a certain action may be performed such as burning content on a disc. It also contains a key necessary to decrypt the content, which is an essential and necessary step before the content can be processed in any way. Without obtaining the license, the in-store burning kiosk 310 cannot decrypt the downloaded content from the content server 340.

In this embodiment when a consumer chooses to buy a movie at an in-store burning kiosk 310 located in a media store 330, a download of an encrypted movie will be initiated from a content server 340. Alternatively, if the requested title has been downloaded before, it may already be available on that specific in-store burning kiosk 310. At this point, an application on the in-store burning kiosk 310 will be started to burn the title to a blank DVD-video media prepared for CSS burning. The implementation of the described embodiment is clearly dependent upon currently proposed changes to DVD Copy Control Association's CSS procedural specification. The acronym CSS, as stated above, stands for content scrambling system. It is the encryption standard used for protecting DVD-video discs against illegitimate copying.

Used in the context of CSS encryption, a title key specifies a key used to encrypt a particular title residing on a DVD-video disc. The notion of a title is not easily recognizable by a regular user. Typically, a title would be a menu option appearing in the disc menu of a DVD-video such as the main movie title or additional documentary, cinematic trailer, etc. The disc key is also used in the context of CSS encryption, a disc key specifies a key used for indirectly encrypting an entire DVD-video disc. The disc key is used to protect the various title keys encrypting the titles on a DVD-video disc. In one embodiment, the digital content or the movie content is provided by the content server 340 through a so-called disc image. A disc image is a file containing the logical representation of a disc. In this context, a disc image describes the content of a DVD-video disc being stored on the content server 340, provided for downloading and even for local storage at an in-store burning kiosk 310. There are several different ways to describe the logical content of a DVD-video disc, for example a very wide spread of which is Nero's image file format with the extension “*.nrg”. This format could, for example, be used for the deployment of the described embodiment.

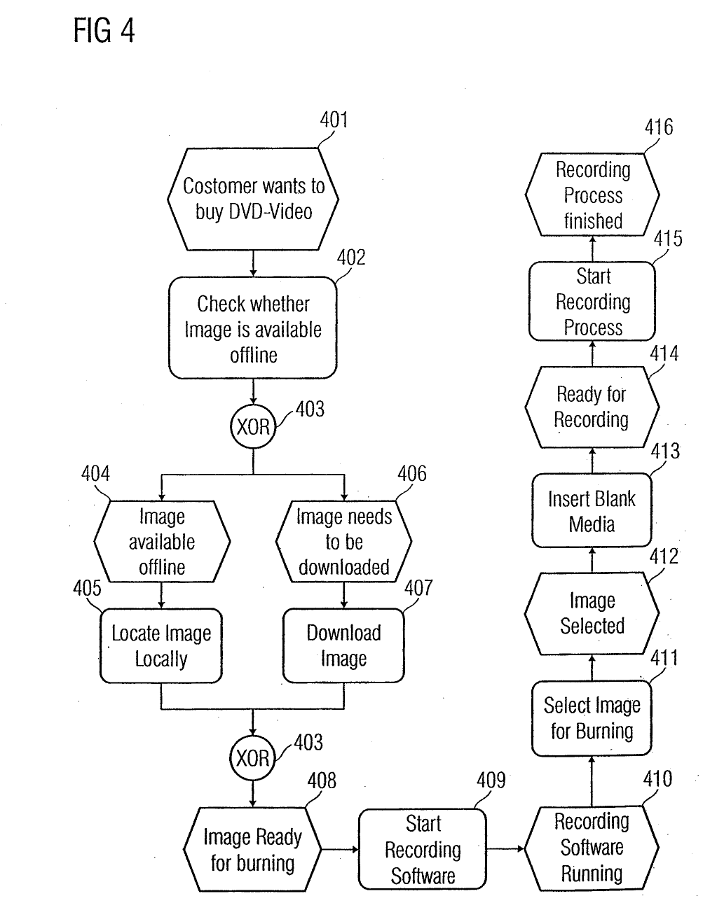

FIG. 4 depicts a flow chart of an exemplary application that could be executed at an in-store burning kiosk 310 as another embodiment. In a first step 401, a costumer wants to buy a DVD-video disc. The in-store burning kiosk 310 checks in a next step 40 whether the image is available off-line, i.e. if the image was downloaded before. According to the “xor”-decision 403 in the flow chart shown in FIG. 4, there are two possibilities for the image location. If the image is available off-line, then the media burning kiosk 310 locates the image locally, which is indicated in steps 404 and 405 in FIG. 4. If the image is not available off-line, it needs to be downloaded, which is then carried out by the in-store burning kiosk 310 as well, indicated by steps 406 and 407 in FIG. 4. After the image was made available, the image is ready for burning, which is indicated by step 408 and the recording software is started in a step 409. Once the recording software is running in step 410, it selects the image for burning in a step 411, and after the image was selected in step 412, a blank media needs to be inserted in the in-store burning kiosk 310 as indicated in step 413. After the blank media was inserted in step 413, the in-store burning kiosk 310 is ready for recording indicated in step 414 and the recording process is started in step 415. Once the recording process is finished in step 416 and the media is made available to the customer. The customer is then charged for the medium in the traditional way, e.g. an invoice is printed at the media burning kiosk 310, which is to be paid at the cashier of the media store 330.

Once the burning process has been started in step 409 in FIG. 4, the application will automatically order a license at the clearing-house server 350 using the store account assigned to the in-store burning kiosk client 310. In one embodiment of the present invention the download of the image as indicated in step 407 is carried out in parallel with the license request. Once the transaction is completed, a license will be issued by the clearing-house server 350 to allow one-time burning of the chosen content and added to the license repository located on the license server 360. The application will then request the license for burning, the license server 360 will reply with the license it just bought. In another embodiment of the present invention the license is requested in parallel with the image download as already mentioned above. Using the license received from the license server 360, the application will decipher the image and write it to the CSS-enabled media using a set of title keys and a disc key contained in the image. It is an advantage of the embodiments of the present invention that the download of the encrypted digital content and the process for requesting and obtaining the license can be executed in parallel by the media burning kiosk 310.

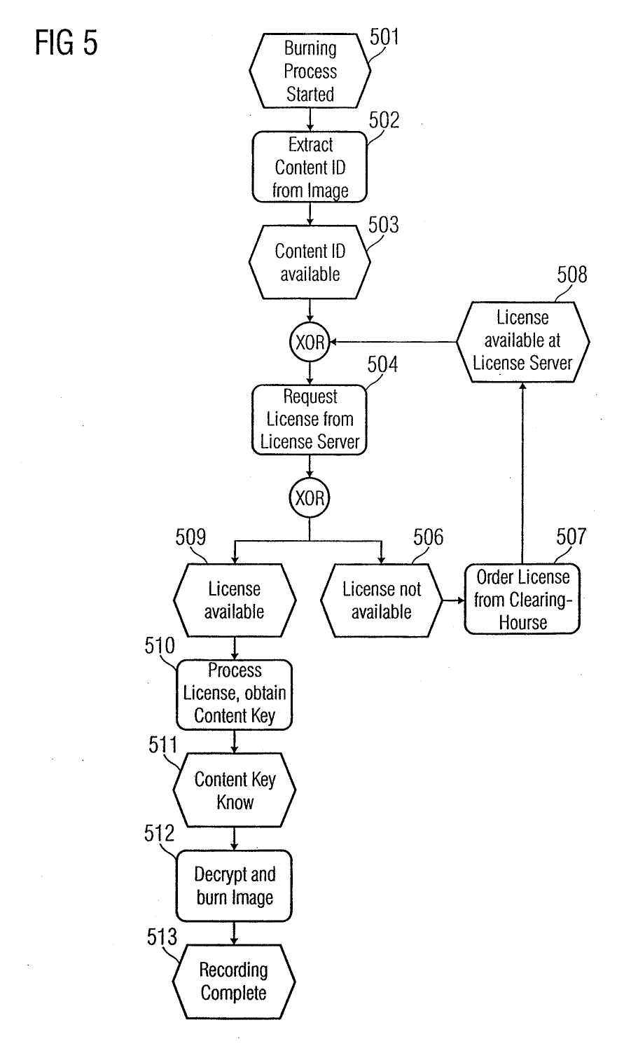

A flow chart detailing this process is depicted in FIG. 5. In FIG. 5, the burning process of the media is started in a first step 501. From the image, which was downloaded from the content server 340, respectively which was already available at the media burning kiosk 310, a content ID is extracted in a step 502 upon which the content ID is available to the in-store burning kiosk 310 in step 503. As stated above, the download of the image and of the license may be executed in parallel, e.g. the content ID may be available at the media burning kiosk 310 in a look-up table. The application running at the in-store burning kiosk 310 then requests a license from the license server 360 in step 504. If the license As not available, in step 506 the application orders the license from the clearing-house server 350 in step 507. In step 508, the license becomes available at the license server 360, supposing that the account of the particular in-store burning- kiosk 310 permits the clearing-house server 350 to issue the license to the license server 360. Once the license has become available to the application running in the in-store burning kiosk 310 in step 509, a content key is extracted from the license in step 510. Once the content key is known in step 511, the image can be decrypted and burnt in step 512, upon which the recording is completed in step 513.

The resulting DVD-video disc will be CSS encrypted and playable using standard consumer DVD players. The CSS copy protection ensures that without the use of dedicated hacker tools, which are illegal, the media cannot be copied.

In addition to the disc image, in one embodiment of the present invention the content server 340 will keep a digital file available to be used for the creation of a disc booklet and disc label art work readily available for processing the disc printer such as are available from various companies. It allows discs to be recorded and labeled in one go, even if this is not desirable. The disc label may still be printed using a standard laser or a jet printer using disc label applications and cover designers. The consumer will then purchase a full video DVD including casing, booklets, label, cover, and potentially all other metadata.

As mentioned above, in one embodiment content servers 340 store content as encrypted disc images. One known format is, for example Nero's own “*.nrg” format and could be used for the purpose to allow the complexity of whole DVD-video menus and even additional data such as multimedia content playable on personal computers to be represented. Such images can be easily produced from original DVD-video discs using, for example, Nero's image burning capability. A dedicated extension to, for example, Nero's disc image format will be implemented, storing the CSS title and disc keys inside the image. As already mentioned, these keys are necessary to create CSS-protected media.

This process can be automated by deploying, for example, Nero's Nero-API module, a recording and image generation engine that can be easily integrated into other applications. Once an image has been extracted from a DVD-video disc, it will be protected by applying DRM protection. On the in-store burning kiosk 310, the image will be stripped-off its DRM protection hull and written using, for example, Nero's burning engine. A special DRM-enabled version of this software can be deployed in these systems. It will automatically obtain a license for the DVD-video image to be recorded and bill the store for it through the clearing-house server 350.

While the written media are protected against piracy using the well-known CSS copy protection technology, the content must also be adequately protected against piracy when being transferred to an in-store burning kiosk 310, for example over public internet. This is why deployment of the in-store burning kiosk's platform must be done in a secure way, applying best practice rules for producing secure software. In the following, the anti-piracy practice as necessary to protect content on its way onto the CSS-protected disc as well as the DRM system used to protect the right from a logical standpoint are explained.

There are a number of scenarios by which a burning kiosk could be compromised. As content servers 340 are accessible over the internet in one embodiment, it is within the realm of possibility that an intruder gets physical access to an in-store burning kiosk 310, steels the software and uses it for his own nefarious purposes from a different location, for example from his home, etc. Once such a scenario is known, the software key used for communication with the license server can be revoked. In addition to that, all further licenses are no longer usable by a compromised component to derive the key necessary for burning the content. Revocation of the key means invalidating a license that has previously been issued. In this context, it means invalidating the technical means to access a server or process licenses. This is done cryptographically so it is technically impossible to circumvent a decision to revoke access to content.

The in-store burning kiosk 310 must also support code renewal. Code renewal is a complementary technology to revocation. Once a component has been revoked, or even before this happens, legitimate users will be provided with an updated version of the revoked component. It fixes the security breach that has caused the revocation and re-enables access to content for legitimate users. Life updates ensure that compromised components such as an in-store burning kiosk 310 will be replaced immediately after they have been revoked or even before.

Each authorized in-store burning kiosk is assigned its own individual a 128-bit unique identifier, which is required for retrieving the license necessary for burning content. Without this information, even the original burning kiosk software is unable to retrieve the license for burning content for the license server. As has been mentioned above, all components of the content distribution system including the license servers 360 and the in-store burning kiosks 310 participate in a two-way authenticatiorn. Combined with the revocability mentioned previously, all components that are found to be compromised can be locked-out of the system, including the license servers 360 themselves.

Communication with the license server 360 is always necessary before burning content to a DVD-video disc. This way, a central authority can keep track about the transactions going on. While consumers are not identified, all transactions caused by a specific outlet using a specific in-store burning kiosk 310 can be easily tracked. In the following anti-piracy practices for one embodiment are described, which are an important aspect of any work in relation to content distribution and recording. All components of the described system make use of code obfuscation, meaning multi-threaded calculations, automated code obfuscation techniques and insertion of dummy code to hide the essential routines are used. Furthermore, all components make use of hiding and obfuscation of secret constants and keys, encryption on hard discs, encryption in memory, and splitting of keys and constants into parts and storing them separately in different memory regions. Furthermore, anti-debugging measures such as detecting debuggers and executing different codes upon detection and code and data encryption in memory will be taken.

Moreover, software and module signing and authentication, e.g. DLL (DLL=Dynamic Link Library) will be used in addition to code signing and signature verification, component authentication for secure communication across module boundaries will be carried out. Furthermore, random number generators fulfilling the requirements of FIPS (FIPS=Federal Information Processing Standard) PUB 140-1, particularly the “Security requirements for cryptographic modules” as outlined in section 140-1 will be utilized. Furthermore, using a runtime entropy of at least one random bit per random number produced will be carried out.

Consequently deployed, these technologies will prevent leaking of protected content even when physical access to an in-store burning kiosk 310 is readily available. With everything going through the clearing-house server 340, a typical account abusing scenario is the only possible exploit that can usually be pinned down to a particular individual, just as is the case with traditional theft of physical goods.

The infrastructure provided for digital rights management is a dedicated version of, for example, Nero Digital—DRM, a platform deployed originally for Nero Digital multimedia files.

The DVD-video burning kiosk platform is utilizing its highly secure transfer protocols for license exchange as well as the license description format and content encryption paradigms, which are not dependent on the logical format of the content. License descriptions, although stored in a binary format can be compiled from XML-files (XML=Extensible Mark-up Language) applying syntax described in the well-known XML Schema language. This allows for easy deployment in today's E-commerce environments. XML is a general purpose mark-up language endorsed by the W3C (World Wide Web Consortium). It allows the creation of dedicated, more specialized description languages for data. XML Schema is a definition language for describing XML document structures. It is recommended by the W3C and considered a more powerful successor for very wide-spread XML-DTD (DTD=Document Type Definition). Unlike DTDs, however, XML Schema definitions themselves are implemented in XML.

As content and license information are stored separately, content storage is not a security-relevant component. Thus, content can be downloaded from an HTTP or FTP server without the need for authentication.

The disc images stored on the content server 340 are encrypted using the AES-128 block cipher (AES=Advanced Encryption Standard). Each encrypted disc image is headed by a DRM header carrying the following metadata information necessary to decrypt the protected image file:
URL (URL=Uniform Resource Locator) of License Server, specifies the authoritative license server responsible for managing the content contained in the image;
URL of Info, specifies a location where more information about a content is available;
Content ID, uniquely identifies the content file, this value is used to retrieve the associated burning license;
License Server ID, each instance of a license server has a unique ID, this ID can be used to look up a license server in case of a URL change;
Original Image Size, stores the original size of the disc image in Bytes, this value is required because the encrypted image needs to be padded to a 128 bit boundary to allow AES128-CBC encryption (CBC=Cipher Block Changing Mode).

To facilitate random access to the logical blocks stored inside the image, a new key will be used each 32 kB (32 kB=32768 Bytes) of data. This key is built from the content key contained in the license file associated with the image using AES stream cipher in counter mode:
K_{BlockNumber}=AESEncrypt(KC,ContentID XOR BlockNumber)

BlockNumber is the number of the 32 kB image block to be processed, the first block carrying block number zero.

K_{BlockNumber} is the 128 bit key used to encrypt/decrypt the 32 kB image block carrying block number BlockNumber. Encryption/Decryption is performed in AES-128 CBC mode.

KC is the 128 bit content key s obtained by processing the license associated with the content.

ContentID is the 128 bit unique identifier associated with the content being processed. As the identifier is never reused for different content it is equivalent to a cryptographic nonce when it comes to encryption.

For CBC encryption to work, the size of the image must be a multiple of a 128 bit (128 bits=16 Bytes). This is accomplished by padding the image with null-Bytes if it does not already have the correct Size.

The DRM header stores the actual original size of the image to allow accurate reproduction of the image when it is written.

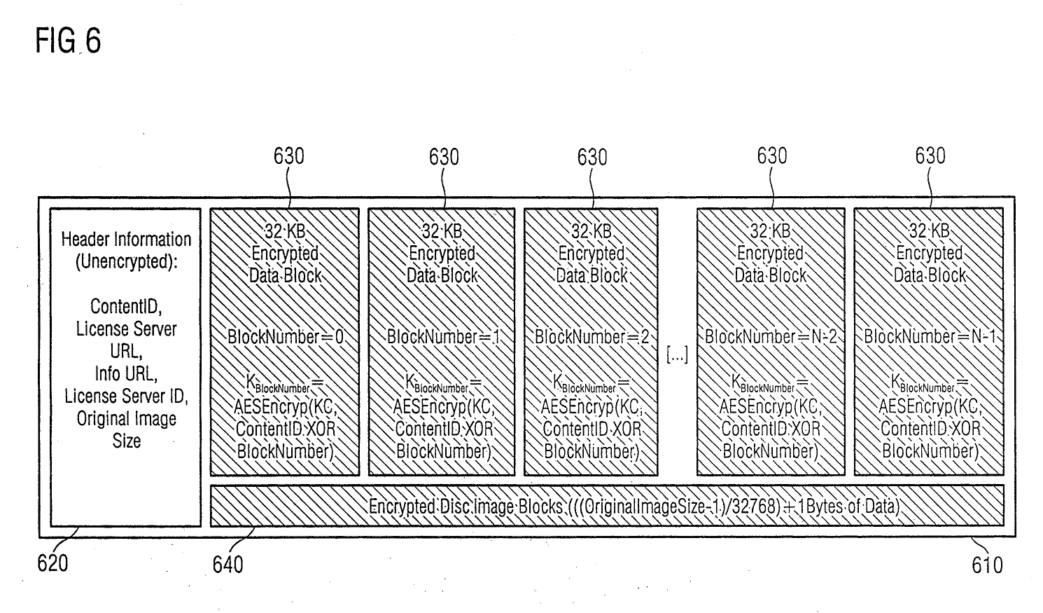

FIG. 6 depicts the structure of an AES-encoded image. FIG. 6 shows the entire image frame 610, the header part 620, which is unencrypted containing content ID, license server URL, info URL, license server ID, original image size. Furthermore, FIG. 6 depicts the information about the individual image blocks 630 as well as the encrypted image blocks 640.

In another embodiment all content recorded with an in-store burning kiosk 310 will be watermarked using watermarks. At minimum, watermarking allows next generation playback devices to refuse playback of unauthorized copies.

Standard watermarking technology merely stores a flag indicating the type of content and on which media type it should reside, for example when set to that specific state, home use content may be played at home from an original media but may not be played from a copy residing on a regular DVD-R(W)/RAM or DVD+R(W) recordable. While this will not prevent playback on old DVD players, next generation devices will be prepared to detect watermarks and react accordingly.

Additionally, forensic watermarking technology can be deployed, tracing illegitimate copies back to the store they were purchased.

Embodiments of the present invention therefore have the advantage that digital content can be provided in a secure and user-friendly manner. It will enable media stores to provide a larger spectrum of media, since not the entire spectrum of media has to be made available at stock. Consumers will certainly benefit from the larger variety of media available at a store. The security mechanisms mentioned and described above will provide a very secure environment for the digital content transmission.

Depending on certain implementation requirements of the inventive methods, the inventive methods can be implemented in hardware or in software. The implementation can be performed using a digital storage medium, in particular a disk, DVD or a CD having electronically readable control signals stored thereon, which cooperate with a programmable computer system such that the inventive methods are performed. Generally, the present invention is, therefore, a computer program product with a program code stored on a machine readable carrier, the proaram code being operative for performing the inventive methods when the computer program product runs on a computer. In other words, the inventive methods are, therefore, a computer program having a program code for performing at least one of the inventive methods when the computer program runs on a computer.

1. Media burning terminal having an account comprising:
a user interface for receiving a user input requesting
a specified piece of digital content;
a network interface for communicating with a clearing-house server managing the account and for communicating with a license server;
a recorder for recording digital content on a portable medium; and
a controller for
reading the user input;
communicating with the clearing-house server for ordering a license for the specified piece of digital content using the account;
receiving the license from the license server;
decrypting the specified piece of digital content using the license; and
controlling the recorder so that the recorder records the decrypted specified piece of digital content on the portable medium.

2. Media burning terminal of claim 1, wherein the network interface is adapted for communicating with a content server for providing encrypted digital content; and
the controller being adapted for downloading encrypted content from the content server.

3. Media burning terminal of claim 2, wherein the controller is adapted for checking whether an encrypted version of the specified piece of digital content is locally available at the media burning terminal and if not, to download the encrypted version of the specified piece of digital content from the content server.

4. Media burning terminal of claim 3, wherein the controller is adapted to use the encrypted specified piece of digital content if it is locally available at the media burning terminal.

5. Media burning terminal of claim 3, wherein the controller is adapted for encrypting the decrypted specified piece of digital content.

6. Media burning terminal of claim 3, wherein the controller is adapted for CSS-encrypting the decrypted specified piece of digital content, the decrypted specified piece of digital content being plain text.

7. Media burning terminal of claim 3, wherein the recorder for recording digital content is adapted for recording CSS-encrypted digital content on CSS-enabled media.

8. Media burning terminal of claim 3, wherein the controller is adapted for downloading the encrypted version of the specified piece of digital content from the content server in parallel to ordering a license from the clearing-house server.

9. Media burning terminal of claim 3, wherein the controller is adapted for also providing metadata for the specified piece of digital content.

10. Media burning terminal of claim 9, wherein the metadata comprises information on a booklet, a label or a cover.

11. Media burning terminal of claim 9, which further comprises a printer, printing metadata for the specified piece of a digital content.

12. Media burning terminal of claim 3, wherein the controller is adapted for recording only a single copy of the specified piece of digital content per license received from the license server.

13. Media burning terminal of claim 3, wherein the controller is adapted for issuing a bill for the provision of the specified piece of digital content with the portable medium.

14. Media burning terminal of claim 11, wherein the controller is adapted for issuing a bill for printed metadata.

15. Media burning terminal of claim 3, wherein the recorder is adapted for burning a video DVD.

16. Method for providing a specified piece of digital content at a media burning terminal, having an account, comprising
a user interface for receiving a user input requesting the specified piece of digital content;
a network interface for communicating with a. clearing-house server managing the account and for communicating with a license server;
a recorder for recording digital content on a portable medium; and
a controller; the method comprising the steps of:
reading the user input;
communicating with the clearing-house server for ordering a license for the specified piece of digital content using the account;
receiving the license from a license server;
decrypting the specified piece of digital content using the license; and
controlling the recorder so that the recorder records the decrypted specified piece of digital content on the portable medium.

17. System for providing a specified piece of digital content, comprising
a communication network;
a content server being coupled to a communication network for providing encrypted digital content;
a clearing-house server being coupled to the communication network, for receiving license orders from a media burning terminal, for managing account data and for issuing a license to a license server;
the license server being coupled to the communication network, for receiving the license from the clearing-house server and for providing the received license to the media burning terminal; and
the media burning terminal being coupled to the communication network for ordering the license for the specified piece of digital content from the clearing-house server, for receiving the license from the license server, for downloading an encrypted version of the specified piece of digital content from the content server, for decrypting the encrypted version of the specified piece of digital content based on the license and for provision of the specified piece of digital content to a user.

18. System of claim 17, wherein the communication network is an internet or a company-wide area network (WAN) respectively a virtual private network (VPN).

19. System of claim 17, wherein the clearing-house server is adapted for issuing a bill for provided digital content to the operator of the media burning terminal.

20. System of claim 17, wherein the license server is adapted for providing a decryption key with a license to a media burning terminal.

21. System of claim 17, wherein the media burning terminal is adapted for ordering the license at the clearing-house server and for downloading the encrypted version of the specified piece of digital content in parallel.

22. System of claim 15, wherein the content server is adapted for providing CSS-encrypted digital data, which is additionally encrypted.

23. System of claim 22, wherein the additional encryption is according to CBC encryption or AES encryption.

24. Method for transferring a specified piece of digital content in a system comprising a communication network, a content server being coupled to the communication network for providing encrypted digital content, the clearing-house server being coupled to the communication network for receiving a license order from a media burning terminal, for managing account data, and for issuing a license to a license server; the license server being connected to the communication network, for receiving the license from the clearing-house server and for providing the license to the media burning terminal; and the media burning terminal being connected to the communication network, the method comprising the following steps:
requesting the specified piece of digital content from the media burning terminal to the clearing-house server;
downloading an encrypted version of the specified piece of digital content from the content server in parallel;
issuing the license from the clearing-house server to the license server;
accounting for the License at the clearing-house server;
providing the license from the license server to the media burning terminal;
decrypt and provide the specified piece of content at the media burning terminal to a user.

25. Computer program having a program code for performing the method of claim 16 or claim 24 when the program code runs on a computer.
